(19) United States
(12) Patent Application Publication
(10) Pub. No.: US 2005/0021344 A1
(43) Pub. Date: Jan. 27, 2005

(54) Access to enhanced conferencing services using the tele-chat system

(75) Inventors: Brent L. Davis, Deerfield Beach, FL (US); Peeyush Jaiswal, Boca Raton, FL (US); Pradeep P. Mansey, Coral Springs, FL (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/626,050

(22) Filed: Jul. 24, 2003

(51) Int. Cl. G10L 11/00

(52) U.S. Cl. 704/277

(57) ABSTRACT

A system (10) and method (50) for enabling phone users to participate in an instant messaging based conference can include the steps of receiving (52) a speech input from a telephone (26 or 28) through a teleconferencing system (24), transcribing (54) the speech input to a first text message and transmitting (58) the first text message to a plurality of devices (18, 20, 26 or 28) coupled to an instant messaging network belonging to the instant messaging based conference. The method can further include the steps of receiving (60) a second text message from any one among the plurality of devices on the instant messaging based conference, converting (62) the second text message to a speech output, and transmitting (68) the speech output to the telephone via the teleconferencing system.

### BACKGROUND OF THE INVENTION

1. Technical Field

This invention relates to the field of telecommunications and more particularly to a telephone conferencing system using real time messaging as well as text-to-speech and speech-to-text conversions.

2. Description of the Related Art

Conferencing using text-based instant messaging (IM) applications is frequently used as a means of collaboration among home users as well as among enterprises. Unfortunately, not everybody has access or is connected to a LAN or the Internet to participate in such text conferences. Mobile people and computer adverse people may not have access to a networked computer and keyboard to participate in an IM-based conference. Many of these users, while not connected, would still like to participate in an IM conference in a manner that is seamless and familiar to them.

Several systems attempt to bridge the gap between voice conferencing and instant messaging system, but such existing systems usually have limitations that prevent a truly user friendly experience in a real-time environment. For example, U.S. Pat. No. 6,430,604 describes a method of delivering instant messages using cell phones and text pagers but using only text entry. Another patent, WO0135615A2, discusses a method of extending an IM system to telephone messaging systems where a user can log into their voice messaging system to communicate with users on their buddy list.

Examples of known systems using text-to-speech and speech-to-text include U.S. Patent Publication US2002/0069069 A1, where such system focuses on communications between participants that can and cannot hear voice conversations, or U.S. Pat. No. 6,339,754 B1, where text-to-speech and speech-to-text technologies coupled with language translation enable chat and voice conferencing, or U.S. Pat. Nos. 6,385,586 B1 or 6,292,769 B1, where text-to-speech and speech-to-text technologies are used to improve language translation between two or more spoken (different language) communications.

Although there are numerous systems using text-to-speech and speech-to-text technologies, none are ideally suited for augmenting voice (and text) chat over data transmission protocols, wherein such protocols can include chat/instant messaging (IM) and messaging protocols such as SMS. None of the existing systems provide a method of delivering voice messages to the intended recipient in the native format of the recipient's device in the language understood by the recipient while also providing a real-time collaboration system that does not necessarily require a voice messaging system to gain access to a conference. Thus, a need exists for a system and method that can overcome the detriments described above.

### SUMMARY OF THE INVENTION

Embodiments in accordance with the invention can include a new technique for enhancing a real-time chat channel to enable telephone users to participate in a instant messaging conference.

In a first aspect of the invention, a method for enabling phone users to participate in an instant messaging based conference can include the steps of receiving a speech input from a telephone through a teleconferencing system, transcribing the speech input to a first text message and transmitting the first text message to a plurality of devices coupled to an instant messaging network belonging to the instant messaging based conference. The method can further include the steps of receiving a second text message from any one among the plurality of devices on the instant messaging based conference, converting the second text message to a speech output, and transmitting the speech output to the telephone via the teleconferencing system.

In a second aspect of the invention, a system for enabling phone users to participate in an instant, messaging based conference can include an input port for receiving a calling party's speech input via a teleconferencing system, a speech-to-text converter for converting the calling party's speech input to a text message for transmission to an instant messaging system, and a text-to-speech converter for converting text messages received from the instant messaging system to a speech output for transmission to the teleconferencing system. The system can further include a telephone coupled to the teleconferencing system and an instant messaging device.

In a third aspect of the invention, a computer program has a plurality of code sections executable by a machine for causing the machine to perform certain steps. The steps can include the steps of receiving a speech input from a telephone through a teleconferencing system, transcribing the speech input to a first text message, transmitting the first text message to a plurality of devices coupled to an instant messaging network belonging to the instant messaging based conference, receiving a second text message from any one among the plurality of devices on the instant messaging based conference, converting the second text message to a speech output, and transmitting the speech output to the telephone via the teleconferencing system.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a flow diagram illustrating an exemplary telecommunications system illustrating an enhanced conferencing system using instant messaging in accordance with the present invention.

FIG. 2 is a flow chart illustrating a method for enabling phone users to participate in an instant messaging based conference in accordance with the present invention.

### DETAILED DESCRIPTION OF THE INVENTION

Embodiments in accordance with the invention can provide a solution for enabling telephone users to participate in an IM-based conference. In a typical IM based conference, all participants are connected to an IM server over a data network and every participant's text message is broadcasted to all the parties in the conference. In accordance with one embodiment, users can call into a system using their wireline or wireless phone, hear messages typed in by the IM participants and can participate by speaking their messages which-can be transcribed into text and broadcast to the IM participants. Such a system can synthesize text messages into speech, transcribe text speech into text and essentially bridge an IM system and a teleconferencing system. Additionally, the system can be personalized by the user to provide a rich end-user experience.

A system 10 for enabling phone users to participate in an instant messaging based conference can include a device 12 that serves as a bridge between a teleconferencing system 24 and an instant messaging system 22. The device 12 can be directly coupled between the teleconferencing system 24 and the instant messaging system 22 or coupled between such systems via an optional data network 17 as shown. Operationally, a conventional phone (26 or 28) on a network 16 such as a PSTN can couple and provide input to and receive input from the device 12 via the teleconferencing system 24. When the phone (26 or 28) provides speech input meant for devices (18 or 20) and their corresponding users on an IM conference, the device 12 can transcribe the speech input to a text message that can be broadcast to all or some of the devices in the IM conference. The devices 18 and 20 can be personal digital assistants, laptop computers, desktop computers, smartphone or essentially any computing device capable of receiving and displaying text messages. The devices 18 and 20 can be coupled to the IM conference via an IM network 14. The device 12 can transmit the text messages to such IM conference participants via an IM system or server 22 and the IM network 14.

A conventional phone (26 or 28) participating in the IM conference can also receive IM messages from other devices in the form of a synthesized speech output. For example, a user inputting text on IM device (18 or 20) would transmit their text message to the device 12 via the IM network 14 and the IM system 22. The device 12 can convert the text message to speech and forward or transmit the speech to the phone 26 or 28 via the system 24 and network 16. Optionally, user profiles 13 (with voice prints or other indicia or a particular user) for devices 18- and 20 (and perhaps users of convention phones that have provided some form of identification when entering the IM conference) can enhance the user experience on conventional phones by reconstructing speech having a simulated voice print of the sending party.

Yet another option would allow for language translation of the text received or converted at device 12. Thus, a user profile 13 corresponding to an IM device 18 can direct the device 12 to translate text received in one language to be transmitted to the device 18 in another language using an optional text translation system 15 coupled to the device 12 for example. Likewise, a phone 26 having a user profile 13 can direct text messages intended for the phone 26 to be translated into another language (using the optional text translation system 15 for example) before speech synthesis so that the user at phone 26 hears speech in a preferred language.

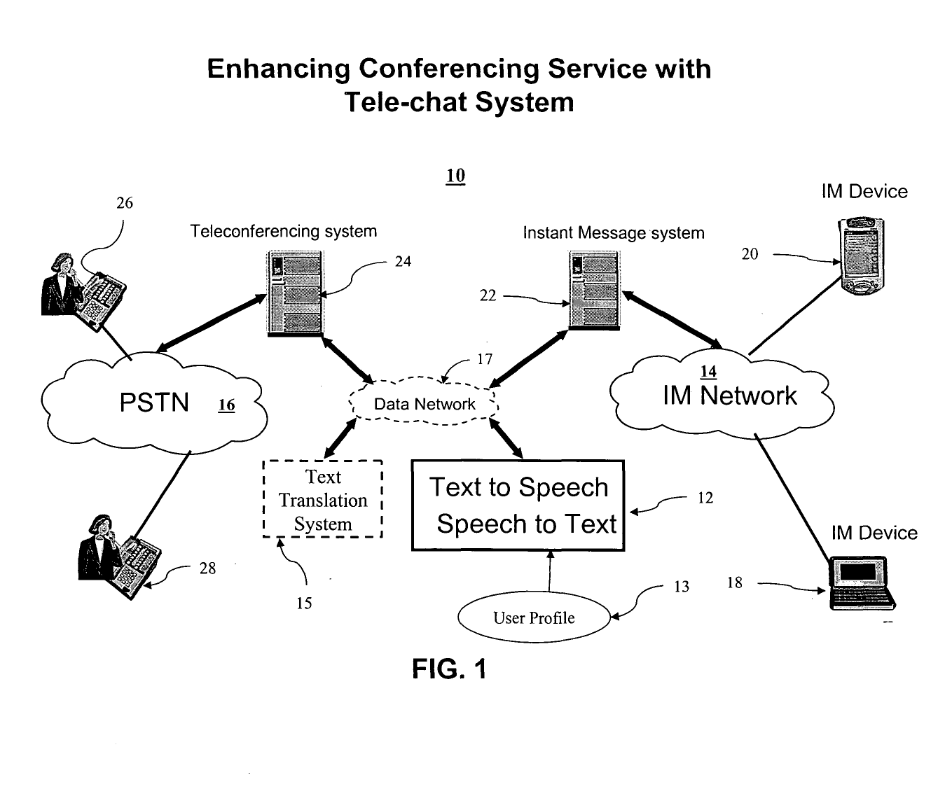

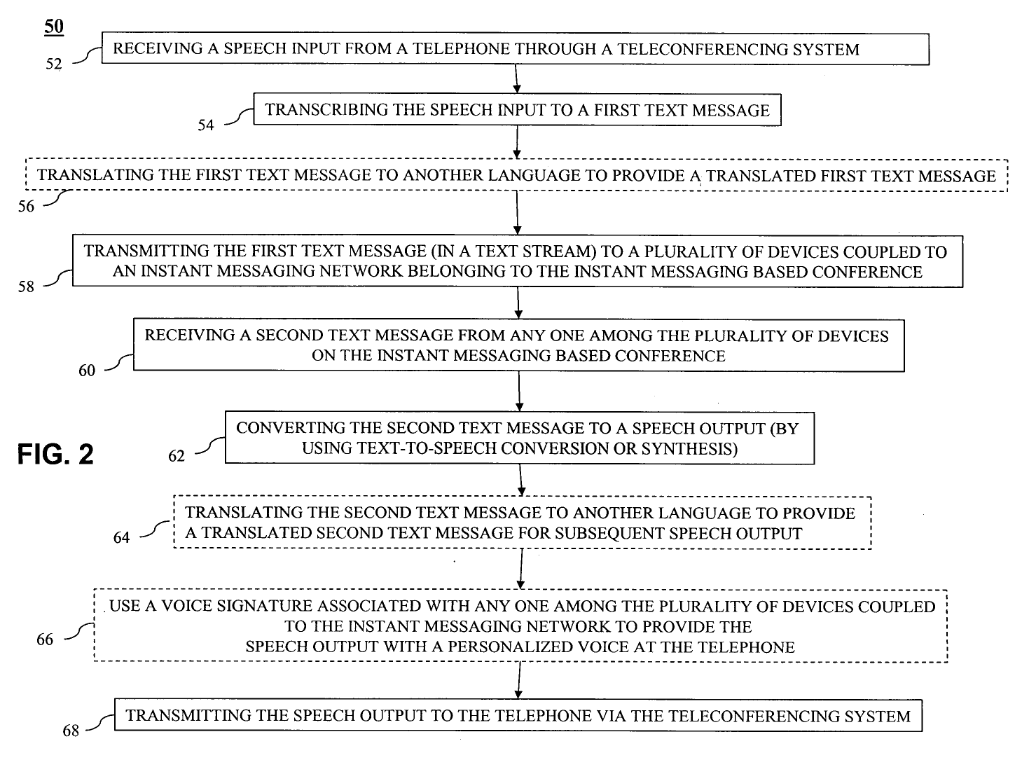

With reference to FIG. 2, a flow chart illustrates a method 50 of enabling a phone user to participate in a IM-based conference. Operationally, the system 10 as shown in FIG. 1 would receiver a speech input from a telephone through a teleconferencing system at step 52. At step 54, the speech input can be transcribed into a first text message. Optionally, at step 56, the first text message can be translated to another language to provide a translated first text message. The user profile 13 of FIG. 1 can be used to set this additional capability if desired. The first text message can be transmitted at step 58 to a plurality of devices coupled to an instant messaging network belonging to the IM based conference. The first text message can be transmitted as a text stream.

With reference again to FIG. 2, the system can receive at step 60 a second text message from any one among the plurality of devices on the IM-based conference. At step 62, the system can convert the second text message to a speech output, preferably by using text-to-speech conversion or synthesis. Once again, the system can optionally translate the second text message to another language to provide a translated second text message for subsequent speech output at step 64. Another option at step 66 enables the system to use a voice signature associated with any one among the plurality of devices coupled to the IM network to provide a speech output with a personalized or customized voice heard at the telephone. Finally, at step 68, the speech output can be transmitted to the telephone via the teleconference system.

It should be understood that the present invention can be realized in hardware, software, or a combination of hardware and software. The present invention can also be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method for enabling phone users to participate in an instant messaging based conference, comprising the steps of:
receiving a speech input from a telephone through a teleconferencing system;
transcribing the speech input to a first text message;
transmitting the first text message to a plurality of devices coupled to an instant messaging network belonging to the instant messaging based conference;
receiving a second text message from any one among the plurality of devices on the instant messaging based conference;
converting the second text message to a speech output; and
transmitting the speech output to the telephone via the teleconferencing system.

2. The method of claim 1, wherein the step of converting the second text message further comprises the step of using a voice signature associated with any one among the plurality of device coupled to the instant messaging network to provide the speech output with a personalized voice at the telephone.

3. The method of claim 1, wherein the step of converting the second text message comprises the step of converting the second text message to the speech output by using text-to-speech conversion.

4. The method of claim 1, wherein the method further comprises the step of translating the first text message to another language to provide a translated first text message.

5. The method of claim 1, wherein the method further comprises the step of translating the second text message to another language to provide a translated second text message for subsequent speech output.

6. The method of claim 1, wherein the step of transmitting the first text message comprises the step of transmitting a text stream.

7. The method of claim 1, wherein the step of converting the second text message comprises the step of converting by using text-to-speech synthesis.

8. A system for enabling phone users to participate in an instant messaging based conference, comprising:
an input port for receiving a calling party's speech input via a teleconferencing system;
a speech-to-text converter for converting the calling party's speech input to a text message for transmission to an instant messaging system; and
a text-to-speech converter for converting text messages received from the instant messaging system to a speech output for transmission to the teleconferencing system.

9. The system of claim 8, wherein the system further comprises a telephone coupled to the teleconferencing system.

10. The system of claim 8, wherein the system further comprises an instant messaging device selected from the group of devices comprising a personal digital assistant, a laptop computer, and a smartphone.

11. The system of claim 8, wherein the system further comprises a translator for translating the text message into another language for transmission to at least one among an instant messaging device as text and to a telephone coupled to the teleconferencing system as a speech output.

12. The system of claim 8, wherein the system further comprises a text-to speech synthesizer.

13. The system of claim 12, wherein the text-to-speech synthesizer uses a voice signature of the called party in producing the audible output.

14. The system of claim 10, wherein the instant messaging device further comprises a display for displaying at least one among the text message from the calling party and text messages from the instant messaging device.

15. The system of claim 10, wherein the text streams are received and transmitted over an instant messaging/chat system in substantially real-time.

16. The system of claim 10, wherein the text streams are received and transmitted over a messaging system using data transmission protocols.

17. The system of claim 8, wherein the system further comprises a user profile for converting at least one among text messages from an instant messaging device into a customized speech output for transmission to the calling party and text messages from the calling party to alternate text messages as defined by a user.

18. A machine-readable storage, having stored thereon a computer program having a plurality of code sections executable by a machine for causing the machine to perform the steps of:
receiving a speech input from a telephone through a teleconferencing system;
transcribing the speech input to a first text message;
transmitting the first text message to a plurality of devices coupled to an instant messaging network belonging to the instant messaging based conference;
receiving a second text message from any one among the plurality of devices on the instant messaging based conference;
converting the second text message to a speech output; and
transmitting the speech output to the telephone via the teleconferencing system.

19. The machine-readable storage of claim 18, wherein the machine-readable storage is further programmed to translate at least one among the first text message to an alternate first text message and the second text message to an alternate second text message for transmission as a speech output.
